(19) United States
(12) Patent Application Publication
(10) Pub. No.: US 2025/0334829 A1
(43) Pub. Date: Oct. 30, 2025

(54) OPTICAL ISOLATOR STRUCTURES

(71) Applicant: HUAWEI TECHNOLOGIES CO., LTD., Shenzhen (CN)

(72) Inventor: Jamal Mohamed Ahmouda ZAID, Ottawa (CA)

(21) Appl. No.: 18/975,213

(22) Filed: Dec. 10, 2024

Related U.S. Application Data
(60) Provisional application No. 63/639,106, filed on Apr. 26, 2024.

(51) Int. Cl. G02F 1/09

(52) U.S. Cl. CPC G02F 1/093

(57) ABSTRACT

An optical isolator structure for antenna systems. The structure includes a metal sheet; a first dielectric layer disposed on a first surface of the metal sheet; a second dielectric layer disposed on a second surface of the metal sheet opposite the first surface of the metal sheet, the first dielectric layer and the second dielectric layer being formed from a first dielectric material; at least one first dielectric split-ring structure disposed on the first dielectric layer; and at least one second split-ring structure disposed on the second dielectric layer, the at least one first dielectric split-ring structure and the at least one second dielectric split-ring structure being formed from a second dielectric material, the second dielectric material having a greater dielectric constant than the first dielectric material.

### CROSS-REFERENCE TO RELATED APPLICATIONS

The present application claims priority to U.S. Provisional Patent Application No. 63/639,106, entitled “Optical Isolator Structures,” filed on Apr. 26, 2024, the entirety of which is incorporated by reference herein.

### FIELD OF THE TECHNOLOGY

The present disclosure generally relates to the field of optical communications and, in particular, to optical isolator structures.

### BACKGROUND

Some communication systems operate at a different band of frequency for both the transmitters and receivers resulting in a communication delay as well as a crowded spectrum (i.e.; half-duplex). Full duplex communication systems, on the other hand, supports simultaneous transmission and reception in narrow time and frequency technique (i.e., transmitter and receiver operate at the same frequency band) that can improve the attainable spectral efficiency by a factor of two compared to some systems (i.e., double throughput). High isolation between transmitting and receiving antennas is required in full-duplex systems to address the self-interference in the transmitted and received signals. Many solutions have thus been proposed for improving the isolation between the transmitters and receivers.

Such proposed solutions include defected ground structure, parasitic elements, and near-field resonators among others. Disadvantages remain in the solutions proposed by the prior art. For instance, most proposed solutions have not exceeded 15 dB isolation. Some isolation structures are further bulky and/or require vias (specifically positioned holes) which make the manufacturing and fabrication of such structures more complicated and costly. Some prior art solutions also require large spacing between the transmitters and receivers which may not be available in some applications.

Therefore, there remains an interest in isolating structures for full duplex communication systems.

### SUMMARY

At least some solutions for overcoming at least some drawbacks present in prior art solutions are disclosed.

The present technology and/or solutions disclose a dielectric split ring resonator (DSRR) structure. The DSRR structure achieves a high isolation between Tx antennas (transmitting) and Rx antennas (receiving). Isolation has been simulated up to 23 dB, providing an absorption of incident electromagnetic waves across its entire band. The proposed structure has ability to absorb up to 90% from incident waves, making it an excellent candidate for full-duplex applications, such as multiple input multiple output (MIMO) arrangements. The proposed DSRR structure further has a simple structure, fabrication of which is fully compatible with standard printed circuit board (PCB) technology.

According to one aspect of the present disclosure, there is provided an optical isolator structure for antenna systems, the structure including a metal sheet; a first dielectric layer disposed on a first surface of the metal sheet; a second dielectric layer disposed on a second surface of the metal sheet opposite the first surface of the metal sheet, the first dielectric layer and the second dielectric layer being formed from a first dielectric material; at least one first dielectric split-ring structure disposed on the first dielectric layer; and at least one second split-ring structure disposed on the second dielectric layer, the at least one first dielectric split-ring structure and the at least one second dielectric split-ring structure being formed from a second dielectric material, the second dielectric material having a greater dielectric constant than the first dielectric material.

In some implementations, the second dielectric layer extends generally parallel to the first dielectric layer.

In some implementations, the at least one first dielectric split-ring structure and the at least one second dielectric split-ring structure are square split-rings.

In some implementations, the optical isolator structure is configured to be used in a Multiple Input Multiple Output (MIMO) antenna arrangement.

In some implementations, the optical isolator structure is configured to be disposed perpendicularly between two antennas of the MIMO antenna arrangement.

In some implementations, the metal sheet is formed from a copper sheet.

In some implementations, the copper sheet has a thickness from about 0.0175 mm to about 0.035 mm.

In some implementations, the metal sheet, the first and second dielectric layers, the at least one first dielectric split-ring structure, and the at least one second split-ring structure form a metamaterial isolator structure.

In some implementations, the first dielectric material of the first and second dielectric layers includes a printed circuit board (PCB) substrate material.

In some implementations, the PCB substrate material has a dielectric constant from about 3.5 and to about 5.5.

In some implementations, the PCB substrate material comprises one of FR-4, CEM-1, CEM-2, CEM-3, polymide, and polytetrafluoroethylene (PTFE).

In some implementations, the second dielectric material of the at least one first dielectric split-ring structure and the at least one second split-ring structure has a dielectric constant of approximately 10.

In some implementations, the second dielectric material of the at least one first dielectric split-ring structure and the at least one second split-ring structure includes a high dielectric constant printed circuit board (high Dk-PCB) substrate material.

In some implementations, the high Dk-PCB substrate material comprises one of Arlon AR1000, Taconic CER-10 and LTCC.

According to one aspect of the present disclosure, there is provided an optical isolator structure for antenna systems, the structure comprising a metal sheet; a first dielectric layer disposed on a first surface of the metal sheet, the first dielectric layer being formed from a first dielectric material; a second dielectric layer disposed on a second surface of the metal sheet opposite the first surface of the metal sheet, the second dielectric layer being formed from a second dielectric material; at least one first dielectric split-ring structure disposed on the first dielectric layer, the at least one first dielectric split-ring structure being formed from a third dielectric material; and at least one second split-ring structure disposed on the second dielectric layer, the at least one second dielectric split-ring structure being formed from a fourth dielectric material, the third dielectric material having a greater dielectric constant than the first dielectric material, the fourth dielectric material having a greater dielectric constant than the second dielectric material.

In some implementations, the second dielectric layer extends generally parallel to the first dielectric layer.

In some implementations, the at least one first dielectric split-ring structure and the at least one second dielectric split-ring structure are square split-rings.

In some implementations, the optical isolator structure is configured to be used in a Multiple Input Multiple Output (MIMO) antenna arrangement.

In some implementations, the optical isolator structure is configured to be disposed perpendicularly between two antennas of the MIMO antenna arrangement.

In some implementations, the metal layer is formed from a copper layer.

In some implementations, the copper layer has a thickness from about 0.0175 mm to about 0.035 mm.

In some implementations, the metal sheet, the first and second dielectric layers, the at least one first dielectric split-ring structure, and the at least one second split-ring structure form a metamaterial isolator structure.

In some implementations, the first dielectric material of the first dielectric layer includes a printed circuit board (PCB) substrate material.

In some implementations, the second dielectric material of the second dielectric layer includes a printed circuit board (PCB) substrate material.

In some implementations, the PCB substrate material has a dielectric constant from about 3.5 and to about 5.5.

In some implementations, the PCB substrate material comprises one of FR-4, CEM-1, CEM-2, CEM-3, polymide, and polytetrafluoroethylene (PTFE).

In some implementations, the third dielectric material of the at least one first dielectric split-ring structure has a dielectric constant of approximately 10.

In some implementations, the fourth dielectric material of the at least one second split-ring structure has a dielectric constant of approximately 10.

In some implementations, the third dielectric material of the at least one first dielectric split-ring structure includes a high dielectric constant printed circuit board (high Dk-PCB) substrate material.

In some implementations, the fourth dielectric material of the at least one second split-ring structure includes a high dielectric constant printed circuit board (high Dk-PCB) substrate material.

In some implementations, the high Dk-PCB substrate material comprises one of Arlon AR1000, Taconic CER-10 and LTCC.

In the context of the present specification, the expression “information” includes information of any nature or kind whatsoever capable of being stored in a database. As such the term information includes, but is not limited to, audiovisual works (images, movies, sound records, presentations etc.), data (location data, numerical data, etc.), text (opinions, comments, questions, messages, etc.), documents, spreadsheets, lists of words, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Quantities or values recited herein are meant to refer to the actual given value. The term “about” is used herein to refer to the approximation to such given value that would reasonably be inferred based on the ordinary skill in the art, including equivalents and approximations due to the experimental and/or measurement conditions for such given value.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

Additional and/or alternative features, aspects and advantages of implementations of the present technology will become apparent from the following description, the accompanying drawings and the appended claims.

### BRIEF DESCRIPTION OF THE FIGURES

The features and advantages of the present disclosure will become apparent from the following detailed description, taken in combination with the appended drawings, in which:

FIG. 1 is a perspective view of a dielectric split ring resonator (DSRR) optical isolator structure according to a non-limiting implementation of the present technology;

FIG. 2 is a perspective, partially transparent view of the DSRR of FIG. 1;

FIG. 3 is a perspective, exploded view of the DSRR of FIG. 1;

FIG. 4 is a side elevation view of the DSRR of FIG. 1;

FIG. 5 is a top plan view of the DSRR of FIG. 1;

FIG. 6 is a top plan view of a larger isolator structure including a plurality of the DSRR of FIG. 1;

FIG. 7 is a graph illustrating the S-parameters of the DSRR of FIG. 1;

FIG. 8 is a graph illustrating the S-parameters and absorption of the DSRR of FIG. 1;

FIG. 9 illustrates the DSRR of FIG. 1 as arranged in operation;

FIG. 10 illustrates two antenna arrangements;

FIG. 11 is a graph illustrating isolation between the antennas of FIG. 10;

FIG. 12 illustrates two antenna and a metal split ring resonator arrangement;

FIG. 13 is a graph illustrating isolation between the antennas of FIG. 12;

FIGS. 14 and 15 illustrate induced currents and radiation of the antenna and DSRR arrangement of FIG. 9;

FIG. 16 is a graph illustrating isolation between the antennas of FIG. 9 when in use with the DSRR of FIG. 1; and

FIG. 17 is a graph comparing isolation between the antennas for no isolator, a metal based isolator (MSRR), and the DSRR of FIG. 1.

It is to be understood that throughout the appended drawings and corresponding descriptions, like features are identified by like reference characters. Furthermore, it is also to be understood that the drawings and ensuing descriptions are intended for illustrative purposes only and that such disclosures are not intended to limit the scope of the claims. In the drawings, the sizes and relative sizes of layers and regions may be exaggerated for clarity. Figures may not be drawn to scale unless otherwise noted.

### DETAILED DESCRIPTION

Representative implementations of the described technology will be described more fully hereinafter with reference to the accompanying drawings, in which the representative implementation is shown. The present technology concept may, however, be embodied in many different forms and should not be construed as limited to the representative implementations set forth herein. Rather, these representative implementations are provided so that the disclosure will be thorough and complete, and will fully convey the scope of the present technology to those skilled in the art.

The present disclosure provides an optical isolator structure 100 configured to be disposed between the transmitter and receiver antennas, especially for Multiple Input Multiple Output (MIMO) antennas in full duplex applications. The optical isolator structure 100 is, in the present implementation, a dielectric split ring resonator 100, referred to herein as the “DSRR” 100, which provides high isolation between the MIMO antennas when in use. In some implementations, the DSRR structure 100 described herein is able to absorb up to 90% from electromagnetic waves incident thereon, resulting in an isolation of 23 dB. The DSRR structure 100, details of which are described in more detail below, is also relatively simple to fabricate and is fully compatible with printed circuit board (PCB) fabrication technology.

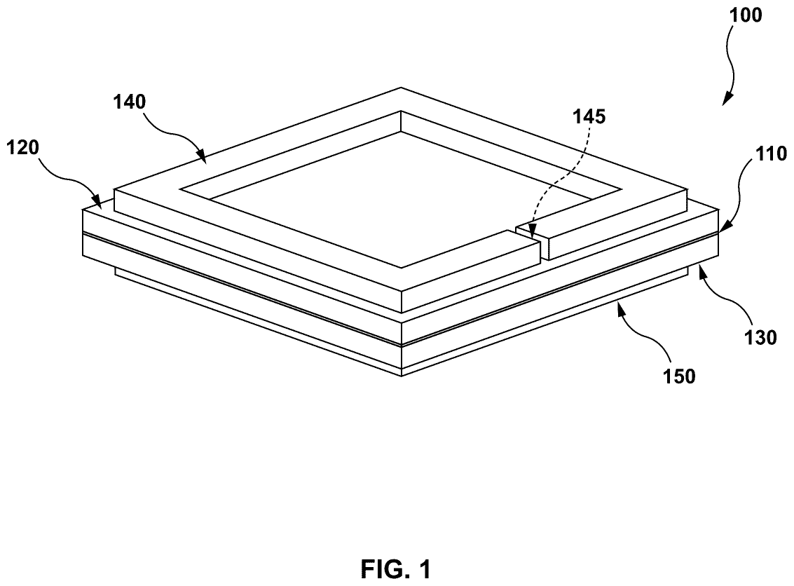

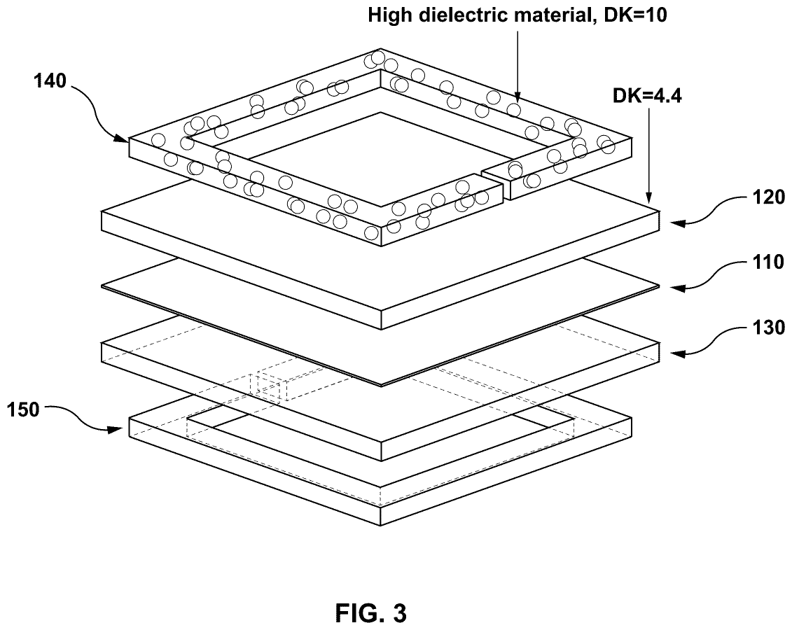

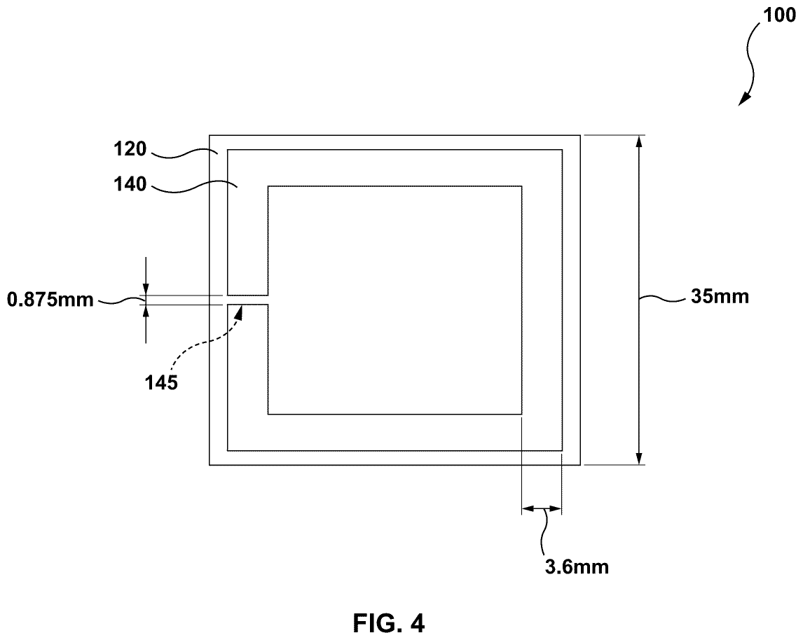

With reference to FIGS. 1 to 5, the DSRR structure 100 is illustrated in more detail. The optical isolator structure 100 includes, at its center, a metal sheet 110. In some implementations, the metal sheet 110 is formed from a layer of copper sheet 110. The copper layer 110 of the present implementation has a thickness from about 0.0175 mm to about 0.035 mm. For the wavelength band of some implementations, e.g., 10.11-10.40 GHz, the thickness of the copper layer 110 is about 0.035 mm.

In some implementations, the DSRR structure 100 includes two dielectric layers surrounding the metal sheet 110. A first dielectric layer 120 is disposed on a first surface of the metal sheet 110. A second dielectric layer 130 is disposed on a second, opposite surface of the metal sheet 110. In some implementation, the dielectric layers 120, 130 are formed from a same dielectric material. In some implementations, it is contemplated that the layers 120, 130 could be formed from different dielectric materials.

In some implementations, the dielectric material of the dielectric layers 120, 130 includes a printed circuit board (PCB) substrate material. The PCB substrate material, of the present implementation, has a dielectric constant from about 3.5 and to about 5.5. The material of some implementations may have a dielectric constant of about 4.4. The material and corresponding dielectric constant chosen could vary in different implementations, e.g., depending on the desired wavelength band of operation, for example. The PCB substrate material of the layers 120, 130 could be chosen from, but is not limited to: FR-4, CEM-1, CEM-2, CEM-3, polymide, and polytetrafluoroethylene (PTFE).

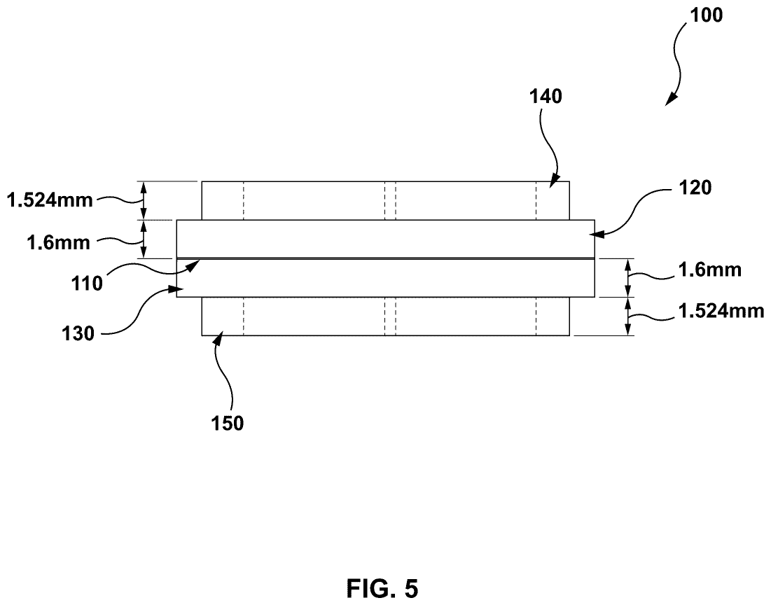

The dielectric layers 120, 130 extend generally parallel to each other. As is illustrated in FIG. 5, the dielectric layers 120, 130 have a thickness of about 1.6 mm in some implementations. The thickness of the dielectric layers 120, 130 could vary in different implementations, depending on the desired wavelength band of operation, for example.

In some implementations, the DSRR structure 100 further includes two dielectric split-ring structures disposed on the two dielectric layers 120, 130. A first dielectric split-ring structure 140 is disposed on the first dielectric layer 120. A second split-ring structure 150 is disposed on the second dielectric layer 130. The dielectric split-ring structures 140, 150 are formed from a dielectric material, generally a different material than the dielectric layers 120, 130.

In some implementations, the dielectric material of the split-ring structures 140, 150 has a greater dielectric constant than the dielectric material of the dielectric layers 120, 130. In at least some implementations, the dielectric material of the split-ring structures 140, 150 has a dielectric constant of approximately 10. The dielectric material of the split-ring structures 140, 150 is formed from a high dielectric constant printed circuit board (high Dk-PCB) substrate material. Depending on the implementation, the high Dk-PCB substrate material can be chosen from, but is not limited to: Arlon AR1000, Taconic CER-10, and LTCC.

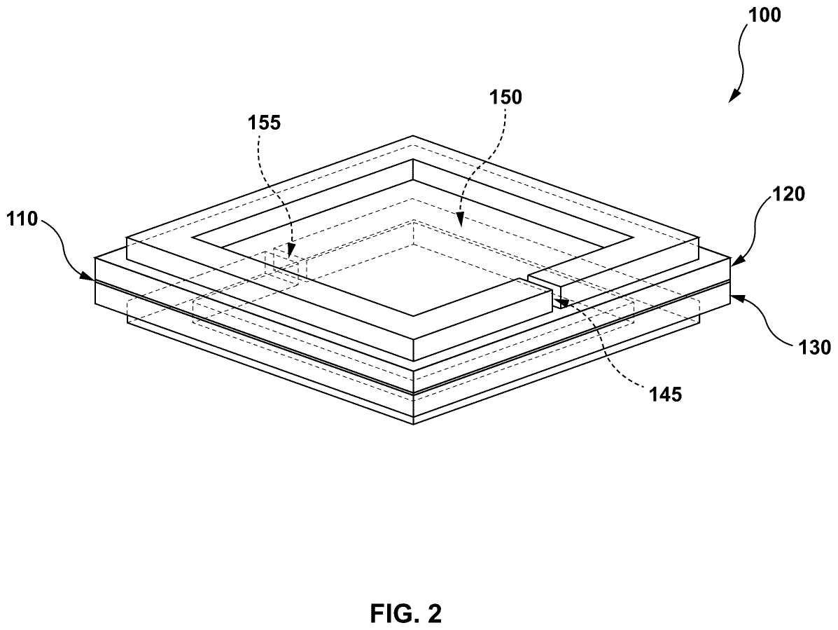

As can be seen from the Figures, the split-ring form of the split-ring structures 140, 150 are raised ridges with a gap in a plane parallel to the metal sheet 110. The split-ring structure 140 has a gap 145. The split-ring structure 150 has a gap 155. As can be seen from the partial-transparent view of FIG. 2, the gap 155 is arranged 180 degrees from the gap 145.

In some implementations, the split-ring structures 140, 150 are square split-rings 140, 150. Square split-rings generally facilitate fabrication of the structure 100. Depending on the particular implementation, however, different shapes of split-rings could be chosen, including but not limited to circular and oval.

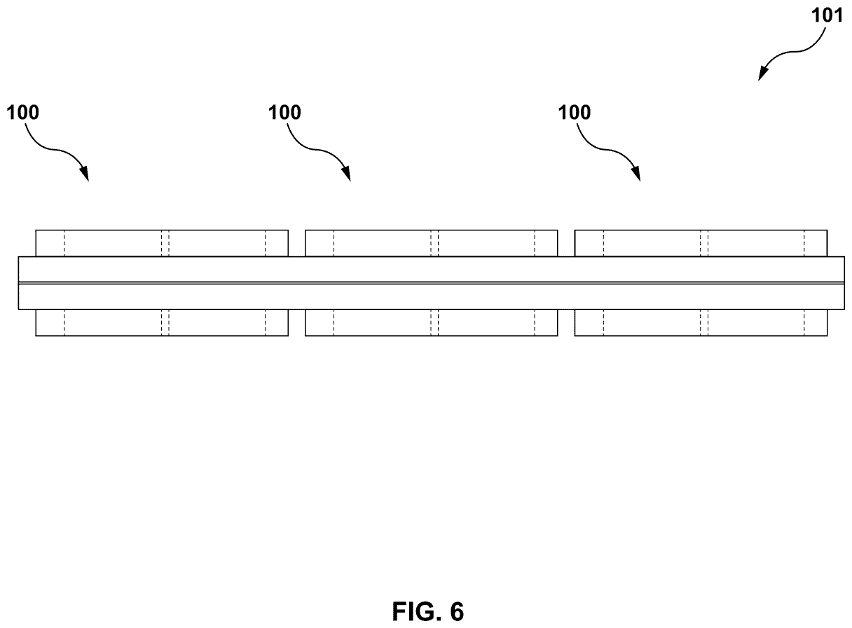

The optical isolator structure 100, formed by the metal sheet 110, the dielectric layers 120, 130, and the dielectric split-ring structures 140, 150, thus forms a metamaterial isolator structure. With additional reference to FIG. 6, it is noted that the structure 100 is a unit cell which represents a minimum structure for performing the isolation of the present technology. Many such unit cell structures 100 can be connected together in order to form a larger optical isolator structure 101.

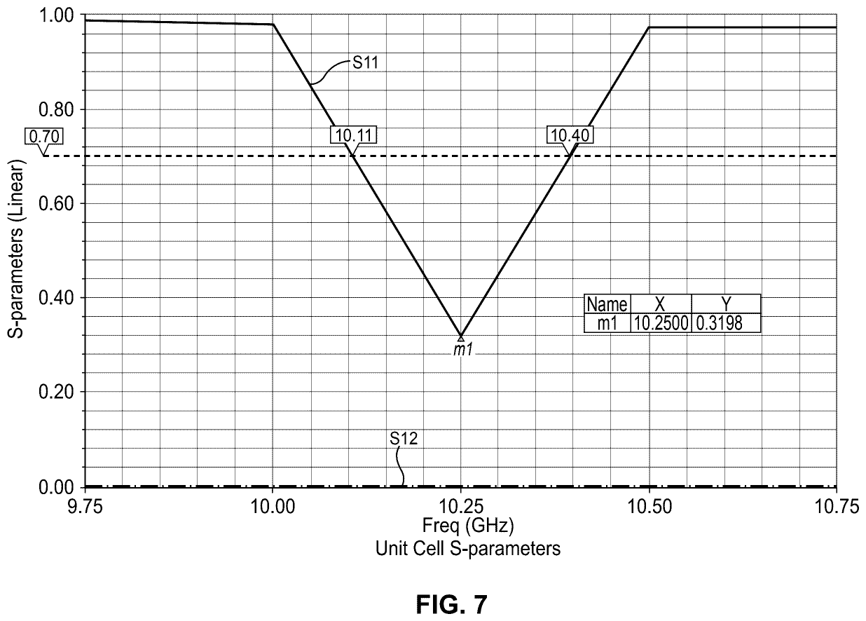

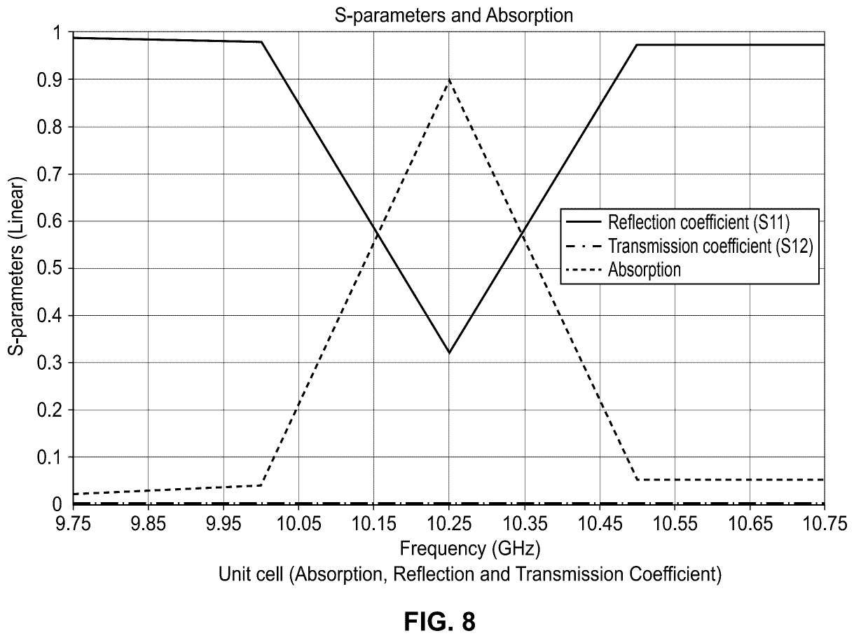

A major property of the DSRR structure 100 is the absorption of electromagnetic radiation so that the structure 100 can be utilized as an absorption wall between transmitting antennas and receiving antennas. To demonstrate the applicability of the present design, the DSRR structure 100 has been tested under specific boundary conditions using standard software of the art (HFSS). The reflection and transmission coefficients, referred to as S-parameters, as determined are plotted in FIGS. 7 and 8. The transmission coefficient (S₁₂) is zero so there is no transmission within the DSRR structure 100. The reflection coefficient (S₁₁) is 0.7 through the band from 10.11 GHz to 10.40 GHz. As such, about 50% of electromagnetic radiation is absorbed by the DSRR structure 100, with about 90% absorbed at the 10.25 GHz. Th absorption ratio A is calculated using the formula (1) below. The absorption of the DSRR structure 100 is plotted in FIG. 8.

$$A = 1 - {S}_{11}^{2} - {S}_{12}^{2} \qquad Eq . ( 1 )$$

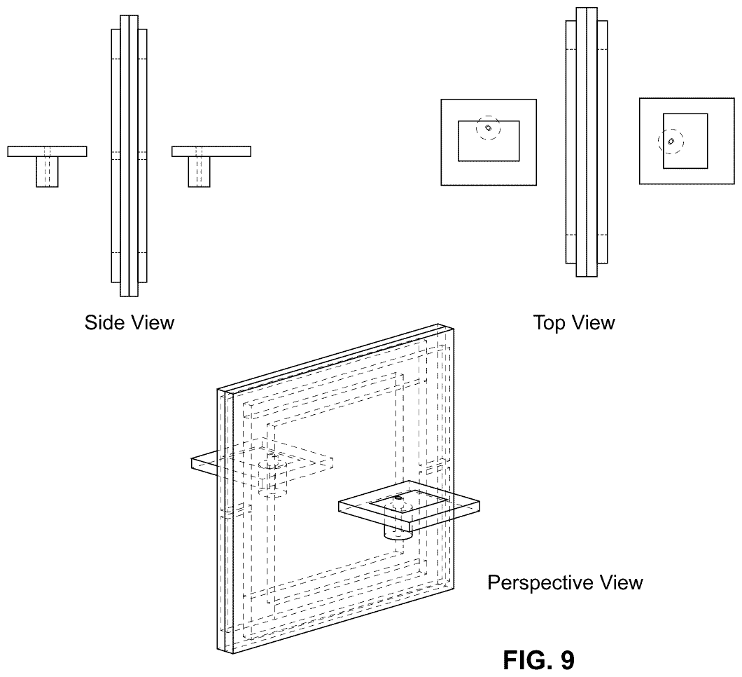

The system architecture in which the DSRR structure 100 is configured to be utilized is illustrated schematically in FIGS. 9 to 12. It is noted that only relevant portions of the architecture are illustrated. It is contemplated that such system architectures could include additional components and the illustrated arrangement is not meant to be particularly limiting. The optical isolator structure 100 is configured to be used in a Multiple Input Multiple Output (MIMO) antenna arrangement. It is contemplated that the optical isolator structure 100 could be used, depending on the specific design of a given implementation, for isolating a myriad of different transmitters and receivers from each other. It is also contemplated that the optical isolator structure 100 could be used to shield equipment or electronic components, for example, from unwanted radiation and signals.

In the present implementations, when in use, the optical isolator structure 100 is disposed perpendicularly between two antennas of the MIMO antenna arrangement. In some implementations, the structure 100 could be differently arranged to the antennas, including for instance with the structure arranged at least partially in plane with one or more of the antennas.

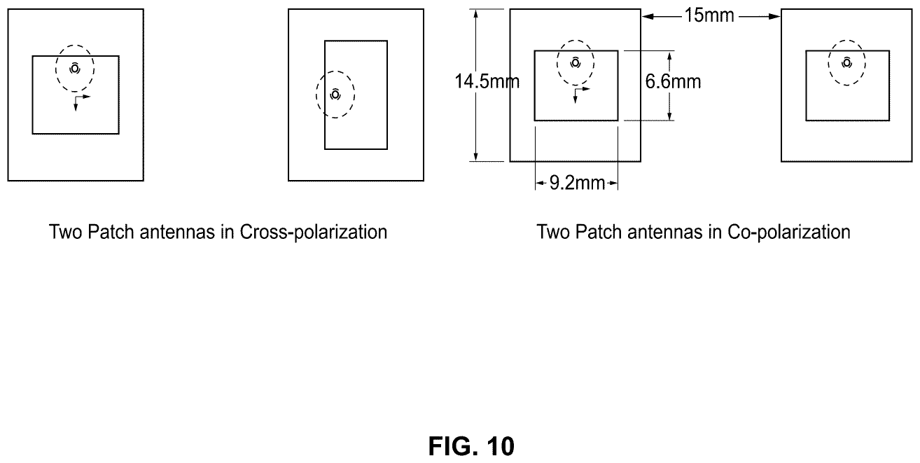

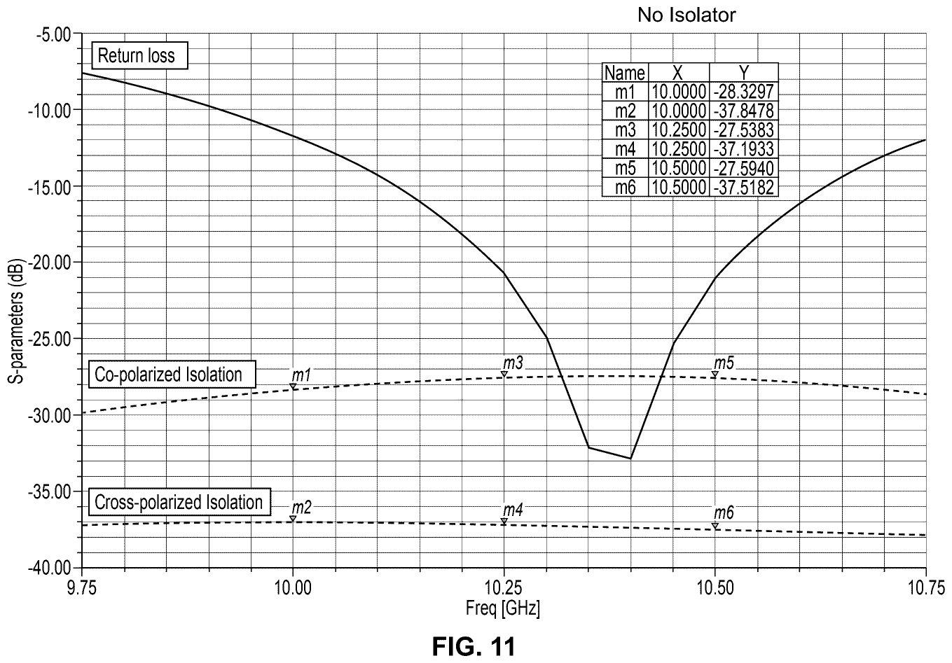

Two antennas are simulated in two different cases as shown in FIG. 10. At left, two patch antennas are in co-polarized and, at right, two patch antennas are in cross polarized. For comparison to the present technology, FIG. 11 illustrates the isolation for the two antenna arrangements without any isolator disposed there between. For the co-polarized case, the return loss spans a frequency band of more than 750 MHz, with isolation at frequencies 10 GHz, 10.25 GHz and 10.5 GHz being 28.3 dB, 27.5 dB and 27.5 dB, respectively. For the cross polarized case, the isolation at frequencies 10 GHz, 10.25 GHz and 10.5 GHz are 37 dB, 37.1 dB and 37.5 dB, respectively. It can be noted that the isolation is increased by roughly 10 dB when used cross polarized than co-polarized.

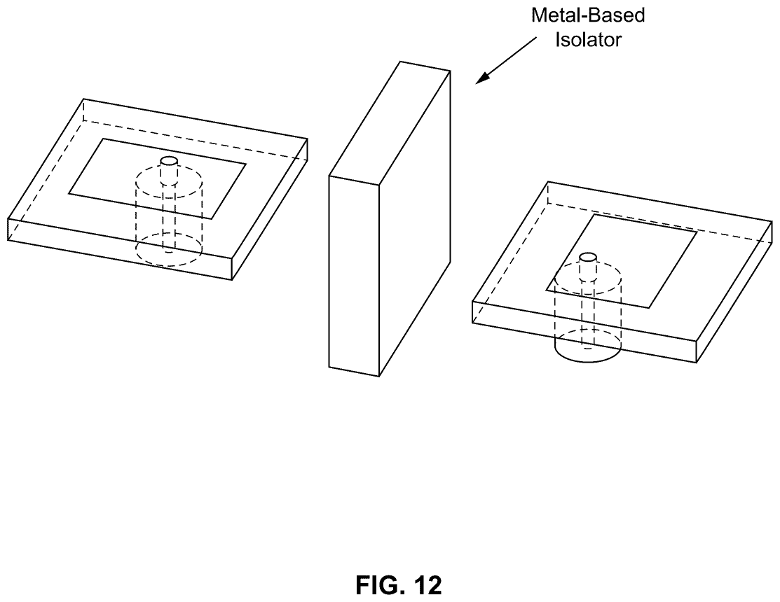

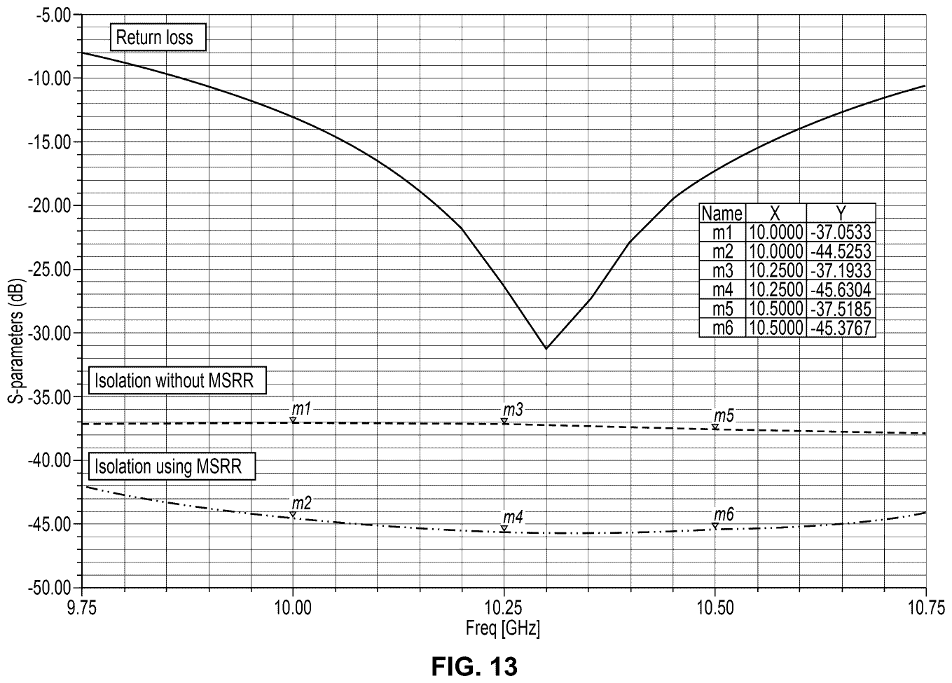

FIG. 12 illustrates a solution to isolating the antennas illustrated in FIG. 10. A Metal Split Ring Resonator (MSRR) or split ring resonator is placed between the antennas to reduce the coupling between antennas. Example simulation results, for comparison to the present technology, of the MSRR as placed between two patch antennas is shown in FIG. 13. As can be seen from the simulation results, the MSRR improves isolation about 8.5 dB as compared to antennas without MSRR (see FIG. 11).

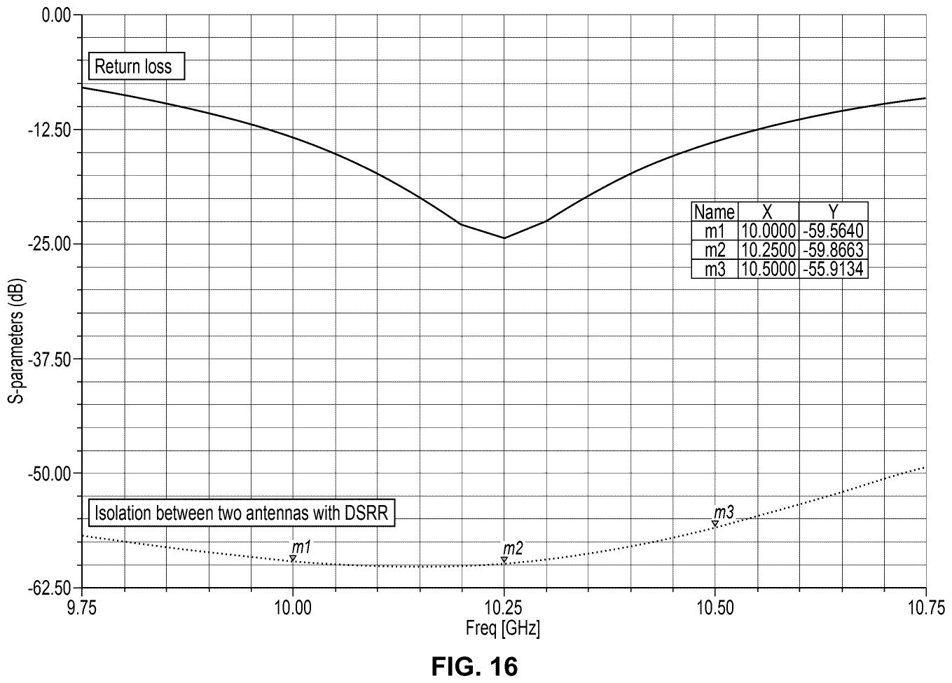

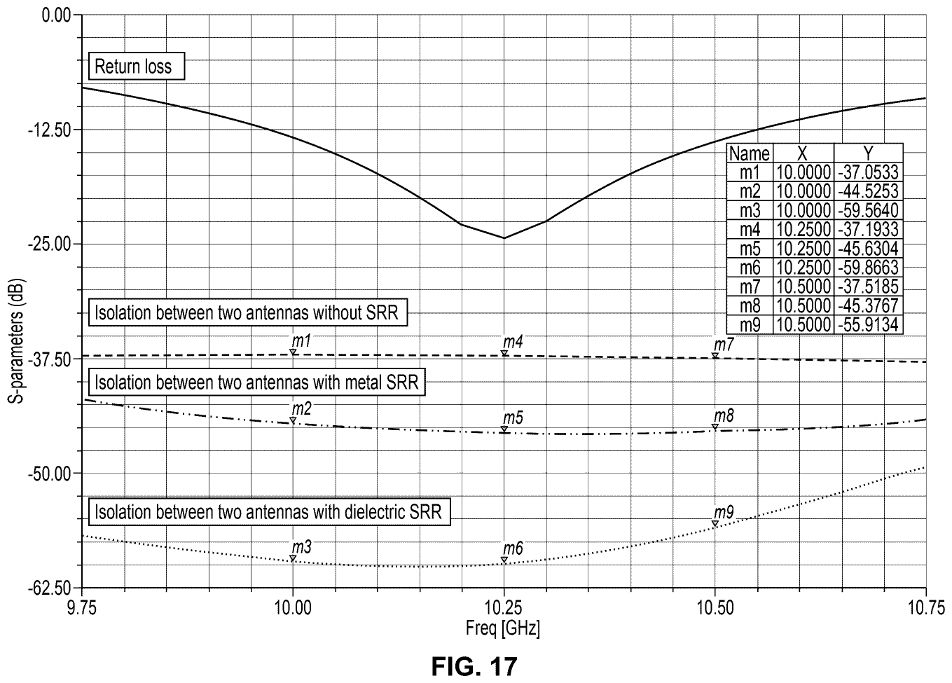

FIGS. 9, 14, and 15 illustrated the DSRR structure 100 in use and disposed between two antennas, with generally the same conditions as the described above. As is discussed above, the reflection and transmission coefficients (S-parameters) for the present antenna arrangement are plotted in FIGS. 7 and 8. FIG. 16 illustrates the isolation, provided by the DSRR structure 100, at 10 GHz, 10.25 GHz and 10.5 GHz which are 59.5 dB, 59.8 dB and 55.9 dB respectively. The isolation at 10.25 GHz is improved by about 23 dB compared to the isolation between the antennas. Additionally, presence of the DSRR structure 100 improves isolation by 14 dB compared to isolation with the MSRR at 10.25 GHz (as one example). A comparison of the three scenarios is also presented in FIG. 17. The isolation of the above two arrangements is further compared to the present technology of the DSRR structure 100 in Table-1 below.

TABLE (1)

| Frequency | 10 GHz | 10.25 GHz | 10.5 GHz |
|---|---|---|---|
| Isolation without | 37 | 37.1 | 37.5 |
| any SRR (dB) | | | |
| Isolation with | 44.5 | 45.6 | 45.3 |
| MSRR (dB) | | | |
| Isolation with | 59.5 | 59.8 | 55.9 |
| DSRR (dB) | | | |

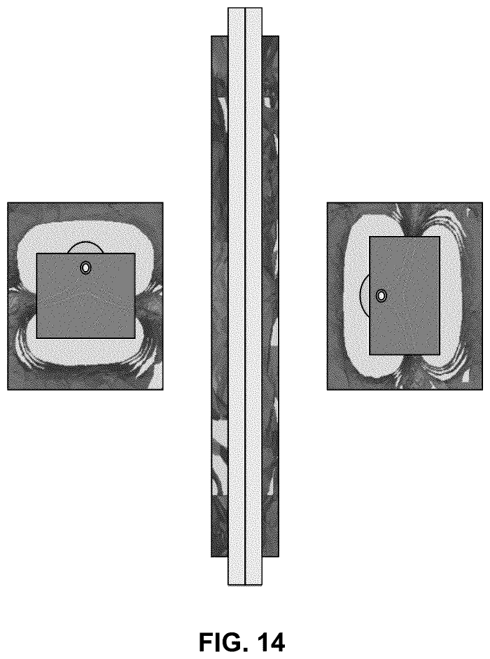

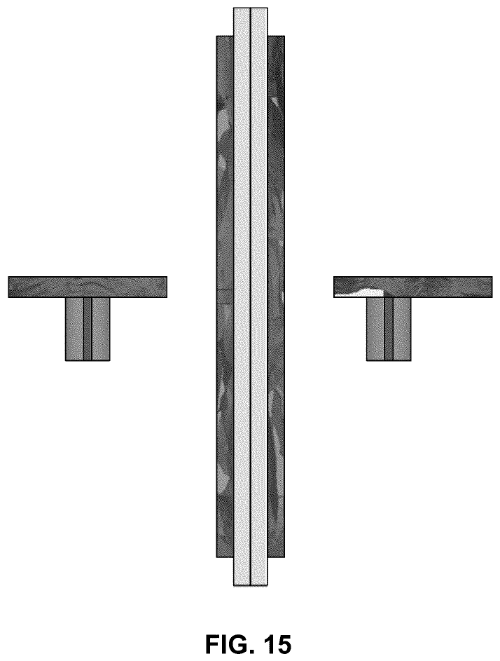

FIGS. 14 and 15 further illustrate the ability of the proposed DSRR structure 100 to absorb electromagnetic waves/radiation. When incident electromagnetic waves encounter the Dielectric Split Ring Resonator (DSRR) 100, currents are induced in the dielectric structure of the split ring resonator. As a result, an interaction between the induced currents in the dielectric rings 140, 150 with the incident electromagnetic waves occurs at the interface between the incident waves and split ring structures 140, 150. This interaction aids in the absorption of the electromagnetic waves. Since the high dielectric material has ability to confine the induced currents, the interaction will be more effectively than the interaction by MSRR, which in turn results in the absorption by the DSRR structure 100 being greater than absorption by a MSRR, for example. An additional interesting feature of the DSRR unit cell 100 is the ability to tune its frequency operating band by controlling the width of the gap, dielectric ring width and/or height, and the dielectric constant chosen. FIGS. 14 and 15 illustrate a simulated antenna radiation and a corresponding simulated confinement of induced currents by the DSRR structure 100.

It should be expressly understood that not all technical effects mentioned herein need to be enjoyed in each and every implementation of the present technology. Modifications and improvements to the above-described implementations of the present technology may become apparent to those skilled in the art. The foregoing description is intended to be exemplary rather than limiting.

What is claimed is:

1. An optical isolator structure for antenna systems, the structure comprising:
a metal sheet;
a first dielectric layer disposed on a first surface of the metal sheet;
a second dielectric layer disposed on a second surface of the metal sheet opposite the first surface of the metal sheet,
the first dielectric layer and the second dielectric layer being formed from a first dielectric material;
at least one first dielectric split-ring structure disposed on the first dielectric layer; and
at least one second split-ring structure disposed on the second dielectric layer,
the at least one first dielectric split-ring structure and the at least one second dielectric split-ring structure being formed from a second dielectric material,
the second dielectric material having a greater dielectric constant than the first dielectric material.

2. The optical isolator structure of claim 1, wherein the second dielectric layer extends generally parallel to the first dielectric layer.

3. The optical isolator structure of claim 1, wherein the at least one first dielectric split-ring structure and the at least one second dielectric split-ring structure are square split-rings.

4. The optical isolator structure of claim 1, wherein the optical isolator structure is configured to be used in a Multiple Input Multiple Output (MIMO) antenna arrangement.

5. The optical isolator structure of claim 1, wherein the metal sheet, the first and second dielectric layers, the at least one first dielectric split-ring structure, and the at least one second split-ring structure form a metamaterial isolator structure. The optical isolator structure of claim 1, wherein the first dielectric material of the first and second dielectric layers includes a printed circuit board (PCB) substrate material.

7. The optical isolator structure of claim 6, wherein the PCB substrate material has a dielectric constant from about 3.5 and to about 5.5.

8. The optical isolator structure of claim 1, wherein the second dielectric material of the at least one first dielectric split-ring structure and the at least one second split-ring structure has a dielectric constant of approximately 10.

9. The optical isolator structure of claim 1, wherein the second dielectric material of the at least one first dielectric split-ring structure and the at least one second split-ring structure includes a high dielectric constant printed circuit board (high Dk-PCB) substrate material.

10. The optical isolator structure of claim 9, wherein the high Dk-PCB substrate material comprises one of Arlon AR1000, Taconic CER-10 and LTCC.

11. An optical isolator structure for antenna systems, the structure comprising:
a metal sheet;
a first dielectric layer disposed on a first surface of the metal sheet, the first dielectric layer being formed from a first dielectric material;
a second dielectric layer disposed on a second surface of the metal sheet opposite the first surface of the metal sheet, the second dielectric layer being formed from a second dielectric material;
at least one first dielectric split-ring structure disposed on the first dielectric layer, the at least one first dielectric split-ring structure being formed from a third dielectric material; and
at least one second split-ring structure disposed on the second dielectric layer, the at least one second dielectric split-ring structure being formed from a fourth dielectric material,
the third dielectric material having a greater dielectric constant than the first dielectric material,
the fourth dielectric material having a greater dielectric constant than the second dielectric material.

12. The optical isolator structure of claim 11, wherein the second dielectric layer extends generally parallel to the first dielectric layer.

13. The optical isolator structure of claim 11, wherein the at least one first dielectric split-ring structure and the at least one second dielectric split-ring structure are square split-rings.

14. The optical isolator structure of claim 11, wherein the optical isolator structure is configured to be used in a Multiple Input Multiple Output (MIMO) antenna arrangement.

15. The optical isolator structure of claim 14, wherein the optical isolator structure is configured to be disposed perpendicularly between two antennas of the MIMO antenna arrangement.

16. The optical isolator structure of claim 11, wherein the metal sheet, the first and second dielectric layers, the at least one first dielectric split-ring structure, and the at least one second split-ring structure form a metamaterial isolator structure.

17. The optical isolator structure of claim 11, wherein the first dielectric material of the first dielectric layer and the second dielectric material of the second dielectric layer include a printed circuit board (PCB) substrate material.

18. The optical isolator structure of claim 16, wherein the PCB substrate material has a dielectric constant from about 3.5 and to about 5.5.

19. The optical isolator structure of claim 11, wherein the third dielectric material of the at least one first dielectric split-ring structure and the fourth dielectric material of the at least one second split-ring structure have a dielectric constant of approximately 10.

20. The optical isolator structure of claim 11, wherein the third dielectric material of the at least one first dielectric split-ring structure and the fourth dielectric material of the at least one second split-ring structure include a high dielectric constant printed circuit board (high Dk-PCB) substrate material.
